(19) United States
(12) Patent Application Publication
(10) Pub. No.: US 2004/0021279 A1
(43) Pub. Date: Feb. 5, 2004

(54) Sanitary cover for shopping cart handle

(76) Inventors: Diana Michelle Sobo, Washington, DC (US); Robin Moselle, Plantation, FL (US); Christopher Mark Tanner, Crystal City, VA (US)

Correspondence Address: Christopher Mark Tanner, Esq., 1201 S. Eads St. # 1811, Crystal City, VA, 22202, US

(21) Appl. No.: 10/207,228

(22) Filed: Jul. 30, 2002

(51) Int. Cl. B62D 39/00

(52) U.S. Cl. 280/33.992

(57) ABSTRACT

A device for improving the sanitary aspects of a shopping cart handle is disclosed. The device wraps approximately two times around the shopping cart handle, and can be made of disposable paper or plastic. The device is secured either through static cling or small amount of manufactured adhesive. A non-disposable embodiment can be made from leather, vinyl, or plastic.

### FIELD OF THE INVENTION

The invention relates to a cover for shopping cart handle which assists in preventing the spread of germs and viruses through human contact.

### BACKGROUND OF THE INVENTION

During a single day, many and perhaps hundreds of people will use a shopping cart, sometimes with a very short duration of time between each use. Consequently, there exists a possibility of coming in contact with germs and other micro-organisms which could spread diseases. This issue is particularly salient in light of the fact that the user is very likely to be handling food, and possibly at the same time handling babies and perhaps multiple babies, which are known to have a high incidence of communicable germs. Therefore, a device for preventing the spread of germs and microbacteria through contact with shopping cart handles is desired.

### BRIEF SUMMARY OF THE INVENTION

In one aspect, the invention provides a sanitary cover for a shopping cart handle, comprising a disposable rectangular sheet to be wrapped approximately two times about the handle and covering at least 80% of the handle, where the sheet has a length of at least 80% of the width of the handle and a width of approximately two times the circumference of said handle; and has sufficient static clinging properties to adhere to the handle yet sufficient rigidity to properly spread across the entirety of the handle without collapsing. In another aspect of the invention, the sheet can be either disposable paper or plastic. In yet another aspect of the invention, the sheet is replaced by a sheath which can be made from leather, plastic, or vinyl.

### BRIEF DESCRIPTION OF THE DRAWING

The foregoing and other features and advantages of the invention will become more apparent from the detailed description of the exemplary embodiments of the invention given below in connection with the accompanying drawings in which:

FIG. 1 is a perspective view of a shopping cart handle with a first embodiment of the present invention wrapped thereupon;

FIG. 2 is a perspective view of a roll of the first embodiment of the present invention; and

FIG. 3 is a perspective view of a second embodiment of the present invention.

### DETAILED DESCRIPTION OF THE INVENTION

Shopping cart handles are likely to be contacted by the hands, mouths, and midsections of many people in a single day, as well as babies. Unfortunately, it is not customary within the grocery and merchandise industry to routinely wash these shopping carts. Consequently, the carts can accumulate a substantial amount of germs, micro-organisms, sweat, dirt, grime, and other unsanitary entities which could be harmful and/or assist in the spread of disease. The present invention contemplates several ways to greatly inhibit the unsanitary risks associated with a typical shopping cart handle, and can be easily implemented without major modification to a shopping environment. The success of devices such as sneeze shields and disposable toilet protectors suggest that the general public, as well as merchandisers, could be in favor of using such protective device.

Also, as disclosed in U.S. Pat. No. 6,065,764, ('764) babies and their associated germs and diseases are often carried near the handle of the shopping cart. The '764 patent also shows that babies are found of chewing and drooling on the cart handle, and using the invention disclosed therein are in fact encouraged to do so. Unfortunately, the possibility of the spread of germs from such a seemingly innocent activity is very large.

Additional factors which could contribute to the spread of germs, bacteria, and other disease-spreading entities through a shopping cart handle include: accumulation of mildew from being left in the rain; sneeze residue; insects and ants commonly found in produce; and the myriad of viruses spread through hand and air contact.

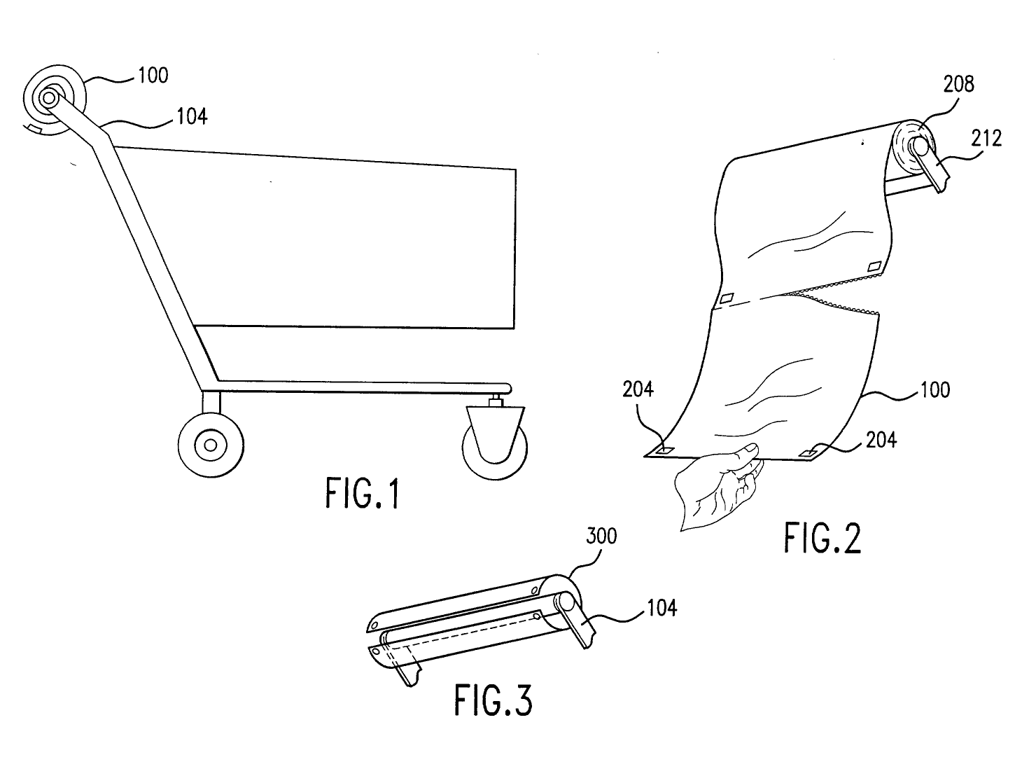

In response to the above, FIG. 1 shows a typical shopping cart handle 104 being protected by a sheet 100 of the present invention. The sheet 100 is measured and manufactured to wrap approximately twice around the shopping cart handle 104. Static adhesion between the surfaces of the sheet 100 is found to be optimum when the sheet 100 is rolled exactly twice around the handle 104. Less than twice around results in the handle 104 not being entirely covered, or the sheet 100 not remaining secure to the handle 104. More than twice around leads to portions of the sheet 100 not adhering to the handle or to itself, and gives rise to the sheet 100 flapping or coming loose.

FIG. 2 shows how the sheet 100 is torn from a perforated roll 208. As shown in FIG. 2, sheet 100 can be made from a similar plastic and perforated similarly to methods used in the manufacture of produce bags. Similar tear-away roll assemblies like those used in produce sections can be placed near the entry of a grocery store a for customer's easy access while picking up a shopping cart. The sheet 100 is meant to be disposable, although re-use is a possibility, and can be secured either by static cling or a small amount of printed adhesive 204 with a peel-away cover located at outer edge of the sheet 100. To achieve an appropriate amount of static cling, the sheet 100 is specifically manufactured to have a certain amount of inherent clinging properties. This clinging property can be varied in manufacture, but is specifically set to be high enough to achieve satisfactory contact adhesion, but low enough to allow for easy removal, disposal, and recycling. Also, because the width of the handle 104 is somewhat longer than typical cling-wrap and baggy assemblies, the sheet 100 must have sufficient rigidity to not collapse upon itself in the way that a sheet of plastic cling-wrap would. Additionally, it is desired that the sheet 100 be tearable using only one hand. This is especially important for shopping establishments that service handicapped customers. Consequently, the sheet 100 must be manufactured with a carefully calibrated amount of rigidity and static electricity properties.

Alternatively, sheet 100 could be made of a thin sheet of paper, similar to those used in toilet-seat protectors. In that case, the static electricity properties of sheet 100 become less important, and a printed adhesive 204 is used to secure the sheet 100. The adhesive 204 can either be a tear-away adhesive as shown in FIG. 2, or a light coating of a strip of stickum which can be fixedly secured by manual pressure while attached to the handle 104, yet not so sticky as to prevent easy unrolling from the perforated roll 208.

FIG. 3 shows a second, non-disposable embodiment of the present invention. This sheath 300 can be made from either leather, vinyl, plastic, or other durable material which can easily be washed. Although the securing means 304 are shown as metal snaps in FIG. 4, this embodiment can also be secured either by velcro, or cloth laces which are permanently secured to the outer surface of the sheath 300. Additionally, although FIG. 3 shows the securing means 304 as being located at the edge of the sheath 300, the securing means could also be located in the middle of the sheath 300.

While the invention has been described and illustrated with reference to specific exemplary embodiments, it should be understood that many modifications and substitutions can be made without departing from the spirit and scope of the invention. Accordingly, the invention is not to be considered as limited by the foregoing description but is only limited by the scope of the appended claims.

What is claimed as new and desired to be protected by Letters Patent of the United States is:

1. A sanitary cover for a shopping cart handle, comprising:
a disposable rectangular sheet to be wrapped approximately two times about said handle and covering at least 80% of said handle,
said sheet having a length of at least 80% of the width of said handle, and a width of approximately two times the circumference of said handle;
wherein said sheet has sufficient static clinging properties to adhere to said handle yet sufficient rigidity to properly spread across the entirety of said handle without collapsing.

2. The cover of claim 1, wherein said sheet is formed of plastic.

3. The cover of claim 1, wherein said sheet is formed of paper.

4. The cover of claim 1, wherein said sheet originates from a perforated roll.

5. The cover of claim 2, further comprising:
said sheet being equipped with adhesive pads having peel-away covers.

6. The cover of claim 3, further comprising:
said sheet being manufactured with a strip of adhesive stickum.

7. The cover of claim 4, further comprising:
said perforated roll being manufactured so that an individual sheet can be torn off with a single hand.

8. A sanitary cover for a shopping cart handle, comprising:
a rectangular sheath to be wrapped one time about said handle and covering at least 80% of said handle,
said sheath having a length of at least 80% of the width of said handle, and a width of approximately two times the circumference of said handle;
wherein said sheath has permanent securing means to reliable secure said sheet to said handle.

9. The cover of claim 8, further comprising:
said sheath being formed from vinyl.

10. The cover of claim 8, further comprising:
said sheath being formed from leather.

11. The cover of claim 8, further comprising:
said sheath being formed from plastic.

12. The cover of claim 8, further comprising:
said securing means being velcro fasteners.

13. The cover of claim 8, further comprising:
said securing means being metal snaps.

14. The cover of claim 8, further comprising:
said securing means being cloth laces.

15. The cover of claim 8, further comprising:
said securing means being disposed at either end of said cover.

16. The cover of claim 8, further comprising:
said securing means being disposed at the middle of said cover.
